(19) United States
(12) Patent Application Publication
(10) Pub. No.: US 2007/0124598 A1
(43) Pub. Date: May 31, 2007

(54) System And Method For Providing Security

(76) Inventors: John K. Schneider, Snyder, NY (US); Donald L. Smith, Williamsville, NY (US)

Correspondence Address: HODGSON RUSS LLP, ONE M & T PLAZA, SUITE 2000, BUFFALO, NY, 14203-2391, US

(21) Appl. No.: 11/557,632

(22) Filed: Nov. 8, 2006

Related U.S. Application Data
(60) Provisional application No. 60/734,835, filed on Nov. 8, 2005.

(51) Int. Cl. H04K 1/00

(52) U.S. Cl. 713/186

(57) ABSTRACT

Systems and methods of providing security by comparing biometric information and access code information are disclosed. In a system according to the invention, there is a biometric reader capable of receiving biometric specimen information, and an adjustable input device used to provide characters of a security access code. That system also includes a controller capable of causing the input device to provide images of characters, which may be randomly positioned on the input device. A database provides authorized biometric samples and corresponding access codes. A microprocessor may be in communication with the biometric reader, the input device and the database, and programmed to carry out certain functions.

### CROSS-REFERENCE TO RELATED APPLICATION

This application claims the benefit of priority to U.S. provisional patent application Ser. No. 60/734,835, filed on Nov. 8, 2005.

### FIELD OF THE INVENTION

The present invention relates to security systems and methods of providing security. For example, the invention may be used to determine whether an individual is permitted to receive a benefit, such as access to an area, perform certain activities or receive certain information.

### BACKGROUND OF THE INVENTION

Many security systems utilize an electronic access and control system in which users are required to provide an access code in order to gain a benefit. The benefit may be to receive money from an ATM machine or it may be to gain access to an area protected by a locked door or to gain access to a device. To this end, there are many devices that allow a person to obtain a benefit upon providing an access code. Other devices require the person to provide a biometric specimen in order to obtain a benefit.

Sometimes such security systems may be compromised and an imposter may be granted access because the imposter employed nefarious means. For example, the keypad unit may be oriented such that an imposter may determine the keys that are pressed by an authorized user in order to enter an access code. The imposter may remember the positions that an authorized user enters, and then duplicate the sequence after the authorized user leaves.

Although biometric input devices provide greater security than keypads, they too can be compromised by an imposter. For example, it is possible to obtain a fingerprint from an authorized person without that person knowing. A latent fingerprint may be lifted with tape, enhanced by means of fuming cyanoacrylate and then used to create a fake finger, sometimes referred to as a “gummy finger”. The fake finger may be presented to the fingerprint reading apparatus, and thereby used to trick the system into believing that the authorized person has presented his or her finger.

Accordingly, a need exists for a biometric security system that provides higher security and resistance to the efforts of an imposter. In an embodiment of the invention, a biometric security system is combined with a keypad security system. The keypad security system provides a keypad having keys, which may be virtual keys displayed on a monitor or discrete keys. Characters displayed on the keys may be rearranged from time to time. In this manner, an unauthorized person may be prevented from gaining a benefit by using a fake biometric or by remembering the positions touched by an authorized user, thereby making the system resistant to unauthorized access.

### SUMMARY OF THE INVENTION

The invention includes systems and methods of providing security. In one such system, there is a biometric reader capable of receiving biometric specimen information, and an adjustable input device used to provide characters of a security access code. That system also includes a controller capable of causing the input device to provide images of characters, which may be randomly positioned on the input device. A database provides authorized biometric samples and corresponding access codes. A microprocessor may be in communication with the biometric reader, the input device and the database and programmed to carry out certain functions. For example, the microprocessor may be programmed to: (a) receive biometric specimen information from the biometric reader, (b) select a biometric sample and an access code from the database, the selected biometric sample and the selected access code being related to each other in the database, (c) compare the received biometric specimen information to the selected biometric sample, (d) determine whether the received biometric specimen information matches the selected biometric sample, (e) receive a security access code provided via the input device, the access code being comprised of characters that are repositioned from time to time, (f) compare the received access code to the selected access code, (g) determine whether the received access code matches the selected access code, (h) authorize a benefit if both (i) the biometric specimen information is determined to match the selected biometric sample, and (ii) the received access code is determined to match the access code corresponding to the selected biometric sample.

In a method according to the invention, (a) biometric specimen information is received from a biometric reader, (b) a biometric sample and an access code are selected from a database, the selected biometric sample and the selected access code being related to each other in the database, (c) the received biometric specimen information is compared to the selected biometric sample, (d) a determination is made as to whether the received biometric specimen information matches the selected biometric sample, (e) a security access code is provided via an input device, the access code being comprised of characters that are repositioned from time to time, (f) the received access code is compared to the selected access code, (g) a determination is made as to whether the received access code matches the selected access code, (h) a benefit is authorized if both (i) the biometric specimen information is determined to match the selected biometric sample, and (ii) the received access code is determined to match the access code corresponding to the selected biometric sample.

### BRIEF DESCRIPTION OF THE DRAWINGS

For a fuller understanding of the nature and objects of the invention, reference should be made to the accompanying drawings and the subsequent description. Briefly, the drawings are:

FIG. 1, which is a schematic representation of a system according to the invention;

FIG. 2, which is a perspective view of a device that may be used in a system according to the invention;

FIG. 3, which is a perspective view of a device similar to that depicted in FIG. 2, but with a view-restrictor added and a keypad having discrete keys in lieu of a virtual keypad; and

FIG. 4, is a flow chart of a method according to the invention.

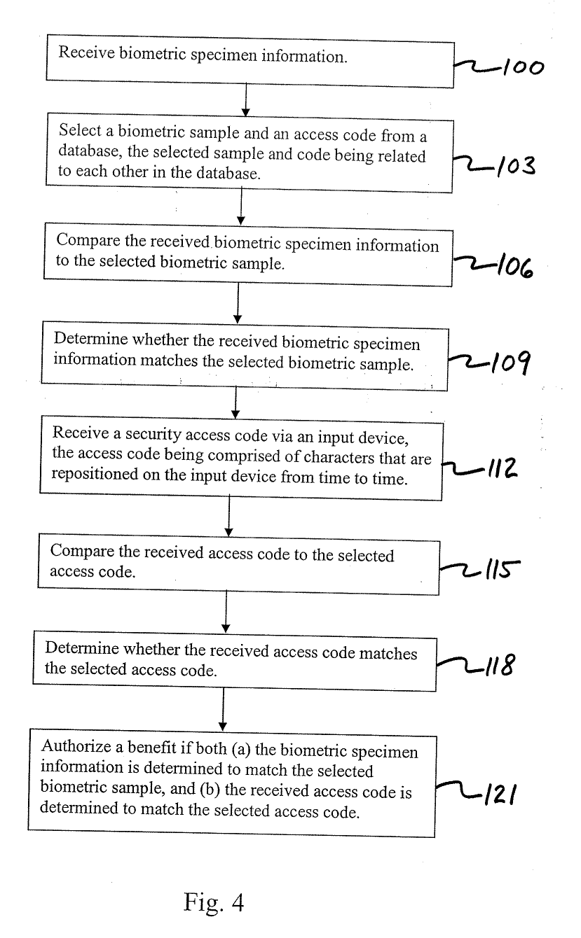

### FURTHER DESCRIPTION OF THE INVENTION

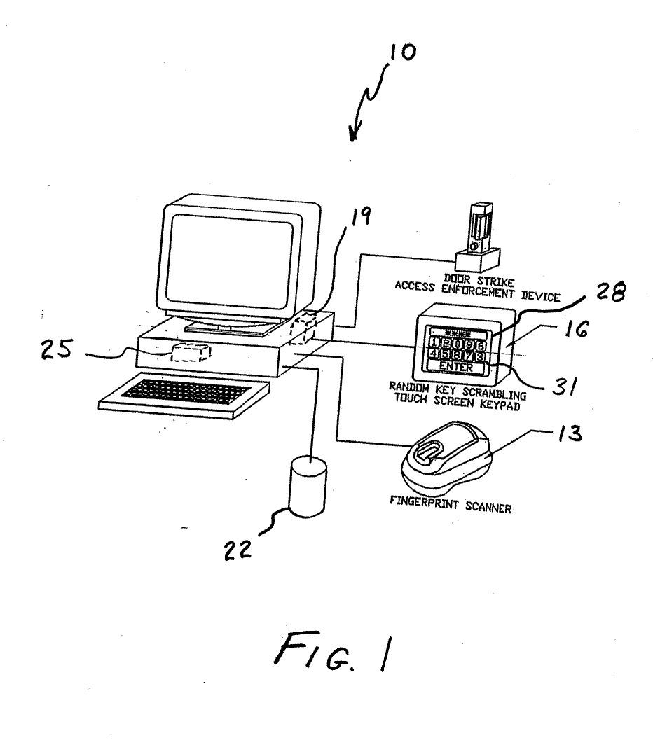

The invention may be embodied as a security system 10, which may be used to provide a benefit, such as allowing access to a secure area, or allowing access to secure documents. FIG. 1 depicts one such system 10. Such a security system 10 may include a biometric reader 13, an adjustable input device 16, a controller 19, a database 22, and a microprocessor 25. Each of these components will be described in more detail below.

The biometric reader 13 may be capable of receiving biometric specimen information. For example, the biometric reader 13 may be an ultrasonic fingerprint scanner. Other types of biometric readers 13 that may be suitable for use with this invention are an iris scanner, a voice recognition system, or a facial image scanner.

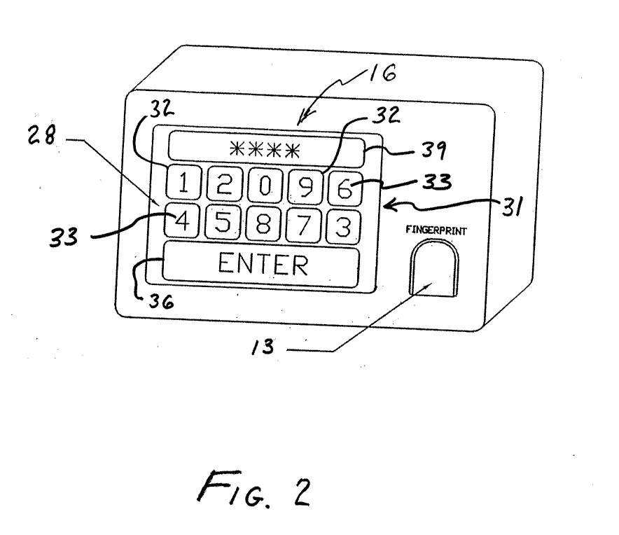

The adjustable input device 16 may be used to provide characters to a user so that the user may provide a security access code via the input device 16. The input device 16 depicted in FIG. 2 has a monitor 28 that displays an image representing a keypad 31 (a virtual keypad), in which the images of eleven virtual keys are displayed. In FIG. 2, ten of the virtual keys have a number character 33 displayed on the key and may be used to enter an access code. These keys are referred to herein as “code keys 32” or sometimes simply “keys 32”. In this example, the number character 33 is a number selected from 0, 1, 2, 3, 4, 5, 6, 7, 8 and 9. The characters 33 may be randomly distributed over the ten virtual codes keys 32, and the characters 33 and/or the virtual code keys 32 themselves may be repositioned from time to time.

Also shown in FIG. 2 is an “ENTER” key 36 and an input window 39. The ENTER key 36 may be used to indicate when entry of the access code has been completed. The input window 39 allows the user to see whether the input device received a character 33 corresponding to a press of one of the code keys 32. In FIG. 2, an asterisk is displayed in the input window 39, rather than the character 33 itself, in order to preserve the secrecy of the access code.

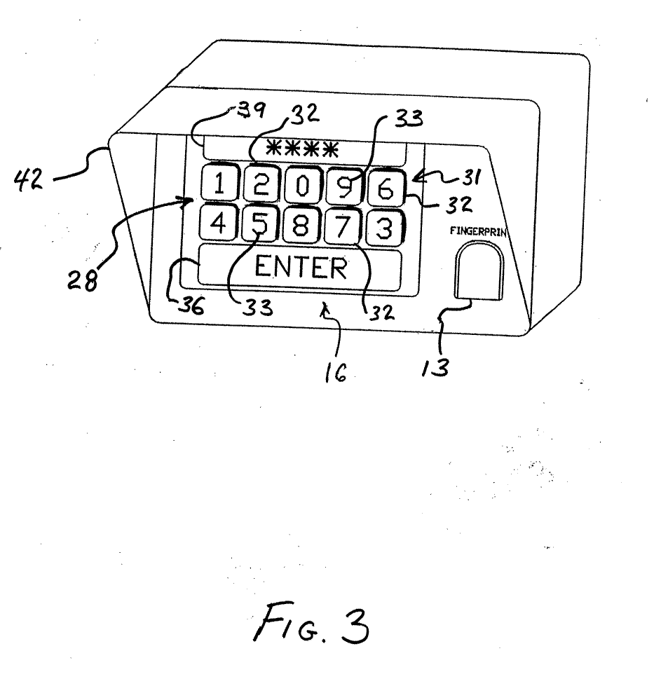

FIG. 3 is another type of adjustable input device 16 in which there are a plurality of discrete movable code keys 32, each of which may display one of the randomly positioned characters 33. The characters 33 on these code keys 32 may be changed from time to time. For example, each code key 32 may have an LCD display for providing the character 33 that may be selected via pressing that code key 32.

The input device 16 of FIG. 3 also differs from that shown in FIG. 2 in that the input device of FIG. 3 includes a view-restrictor 42, which may be used to prevent individuals other than the user from seeing which characters 33 are being entered via the input device 16. The view-restrictor 42 may be a hood that extends over the input device 16 and shields the input device 16 from being seen by others, but allows the user of the system to see the input device 16.

Each of the input devices 16 depicted in FIG. 2 and FIG. 3 are shown housed together with the biometric reader 13. However, the input device 16 and the biometric reader 13 need not be housed together.

The controller 19 may be capable of causing the input device 16 to provide images. The images may include a plurality of randomly positioned characters 33, at least some of the characters 33 being characters in the access code. For example, the images of the numbers 0 through 9 depicted in FIG. 2 and in FIG. 3 may be repositioned from time to time. For instance, the controller 19 may be capable of repositioning the characters 33 prior to fully identifying the security access code. Or the characters 33 may be repositioned each time a character 33 is identified. Alternatively, the controller 19 may be capable of repositioning the characters 33 at predetermined times.

The database 22 may have stored therein information corresponding to authorized biometric samples and corresponding access codes. Each biometric sample will be associated with at least one corresponding access code, so that if the access code is provided, then the biometric sample may be located in the database, and vice versa. The samples and codes may be provided during a pre-authorization step. The pre-authorization step may occur, for example, when a person is first hired by a company. Each biometric sample may have at least one corresponding access code.

The microprocessor 25 may be in communication with the biometric reader 13, the input device 16 and the database 22. The microprocessor 25 may be programmed to receive biometric specimen information from the biometric reader 13. The microprocessor 25 may also be programmed to select a biometric sample and an access code from the database 22, the selected biometric sample and the selected access code being related to each other in the database 22. The microprocessor 25 may also be programmed to compare the received biometric specimen information to the selected biometric sample, and determine whether the received biometric specimen information matches the selected biometric sample. Further, the microprocessor 25 may be programmed to receive a security access code provided via the input device, the access code being comprised of characters 33 that are repositioned from time to time, and compare the received access code to the selected access code. Finally, the microprocessor 25 may be programmed to determine whether the received access code matches the selected access code, and programmed to authorize a benefit if both (i) the biometric specimen information is determined to match the selected biometric sample, and (ii) the received access code is determined to match the access code corresponding to the selected biometric sample. For example, if both matches are determined, the microprocessor 25 may authorize an action, such as permitting a user to access something. For example, a door strike access device (see FIG. 1) may be caused to unlock a door so that the user may open the door and enter a secure room.

The invention may be embodied as a method of providing access. In one such method, biometric specimens and biometric samples are used. Biometric specimen information may be received 100 from a biometric reader. A biometric sample and a related access code may be selected 103 from a database. The received biometric specimen information may be compared 106 to the selected biometric sample, and a determination 109 may be made as to whether the received biometric specimen information matches the selected biometric sample.

The method may also include receiving 112 a security access code via an input device. The access code may be comprised of characters that are repositioned from time to time. The characters may be repositioned when a character has been indicated. Further, the characters may be repositioned at a predetermined time, which may or may not be prior to fully identifying a particular security access code. The received access code may be compared 115 to the selected access code, and a determination 118 may be made as to whether the received access code matches the selected access code. It should be noted that the comparison of access codes may occur before, during or after comparison of biometric information occurs.

If both (a) the biometric specimen information is determined to match the selected biometric sample, and (b) the received access code is determined to match the selected access code, then a benefit may be authorized 121. For example, the benefit may be that a door is opened to allow a person to enter a secure area, or a computer may be enabled to provide secure information.

U.S. provisional patent application No. 60/734,835 discloses additional details about the invention and additional embodiments of the invention. The disclosure of that patent application is incorporated by this reference.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A security system, comprising:
a biometric reader capable of receiving biometric specimen information;
an adjustable input device which is capable of being used to provide characters of a security access code;
a controller capable of causing the input device to provide images, the images including a plurality of randomly positioned characters, at least some of the characters being characters in the access code;
a database having stored therein authorized biometric samples and corresponding access codes, each biometric sample having at least one corresponding access code;
a microprocessor in communication with the biometric reader, the input device and the database, the microprocessor being programmed to:
(a) receive biometric specimen information from the biometric reader;
(b) select a biometric sample and an access code from the database, the selected biometric sample and the selected access code being related to each other in the database;
(c) compare the received biometric specimen information to the selected biometric sample;
(d) determine whether the received biometric specimen information matches the selected biometric sample;
(e) receive a security access code provided via the input device, the access code being comprised of characters that are repositioned from time to time;
(f) compare the received access code to the selected access code;
(g) determine whether the received access code matches the selected access code;
(h) authorize a benefit if both (i) the biometric specimen information is determined to match the selected biometric sample, and (ii) the received access code is determined to match the access code corresponding to the selected biometric sample.

2. The security system of claim 1, wherein the input device includes a view-restrictor.

3. The security system of claim 1, wherein the controller is capable of repositioning the characters when a character has been identified.

4. The security system of claim 1, wherein the controller is capable of repositioning the characters prior to fully identifying the security access code.

5. The security system of claim 1, wherein the controller is capable of repositioning the characters at predetermined times.

6. The security system of claim 1, wherein the input device includes a plurality of discrete keys, each of which displays at least one of the randomly positioned characters.

7. The security system of claim 1, wherein the input device includes a monitor capable of displaying the randomly positioned characters.

8. A method of providing access, comprising:
receiving biometric specimen information from a biometric reader;
selecting a biometric sample and an access code from a database, the selected biometric sample and the selected access code being related to each other in the database;
comparing the received biometric specimen information to the selected biometric sample;
determining whether the received biometric specimen information matches the selected biometric sample;
providing a security access code via an input device, the access code being comprised of characters that are repositioned from time to time;
comparing the received access code to the selected access code;
determining whether the received access code matches the selected access code;
authorizing a benefit if both (i) the biometric specimen information is determined to match the selected biometric sample, and (ii) the received access code is determined to match the access code corresponding to the selected biometric sample.

9. The method of claim 8, wherein the characters are repositioned when a character has been indicated.

10. The method of claim 8, wherein the characters are repositioned prior to fully identifying the security access code.

11. The method of claim 8, wherein the characters are repositioned at predetermined times.
